(19) United States
(12) Patent Application Publication
(10) Pub. No.: US 2015/0338153 A1
(43) Pub. Date: Nov. 26, 2015

(54) INSULATED FRAME FOR TRANSPORTATION REFRIGERATION UNIT

(71) Applicant: Carrier Corporation, Farmington, CT (US)

(72) Inventors: Wenping ZHAO, Glastonbury, CT (US); Gopal R. KRISHNAN, Wethersfield, CT (US); Ellen Y. SUN, South Windsor, CT (US); Vijay JAGDALE, Manchester, CT (US); Shunjun SONG, Cortland, NY (US); Mark Patrick RAU, Fairport, NY (US); Mary Teresa LOMBARDO, Windsor, CT (US)

(21) Appl. No.: 14/652,640

(22) PCT Filed: Oct. 17, 2013
(86) PCT No.: PCT/US2013/065457

§ 371 Date: Jun. 16, 2015

Related U.S. Application Data
(60) Provisional application No. 61/738,006, filed on Dec. 17, 2012.

(51) Int. Cl. F25D 11/00; F25D 23/06; B65D 81/38; F16M 1/08

(52) U.S. Cl. CPC F25D 11/003; F16M 1/08; F25D 23/067; B65D 81/3816

(57) ABSTRACT

A refrigerated cargo container includes a refrigeration unit and a cargo container. The refrigeration unit includes a support frame formed from at least one layer of composite material and at least one layer of insulative foam material. The support frame is supportive of one or more components of the refrigeration unit and insulative of a cargo portion of the cargo container.

### BACKGROUND OF THE INVENTION

The subject matter disclosed herein relates to transportation refrigeration systems. More specifically, the subject matter disclosed herein relates to support structures for transportation refrigeration systems.

Transportation refrigeration systems, such as those for refrigerated shipping containers typically include an insulated support frame to support and contain the components of the refrigeration system such as a compressor, condenser, evaporator, fan and other refrigeration system components. The support frame is typically formed from multiple aluminum sheets and extrusions, which are assembled by welding and riveting, then sealed. Insulating foam is injected between front an rear aluminum panels of the support frame. The aluminum frame is susceptible to corrosion, especially when used in overseas shipping containers. Further, the manufacture and assembly of the aluminum frame is costly and is also heavy which adds to costs of utilizing the container.

### BRIEF DESCRIPTION OF THE INVENTION

In one embodiment, a refrigerated cargo container includes a refrigeration unit and a cargo container. The refrigeration unit includes a support frame formed from at least one layer of composite material and at least one layer of insulative foam material. The support frame is supportive of one or more components of the refrigeration unit and insulative of a cargo portion of the cargo container.

In another embodiment, a support frame for a refrigeration unit of a refrigerated cargo container includes one or more layers of composite material and at least one layer of thermally insulative material secured thereto. The support frame is supportive of one or more components of the refrigeration unit and is thermally insulative of a cargo portion of the cargo container.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic of an embodiment of a refrigerated cargo container;

FIG. 2 is a schematic view of an embodiment of a refrigeration system for a cargo container refrigeration unit;

FIG. 3 is a schematic view of an embodiment of a frame support for a cargo container refrigeration unit;

FIG. 4 is a schematic view of another embodiment of a frame support for a cargo container refrigeration unit;

FIG. 5 is a schematic of yet another embodiment of a frame support for a cargo container refrigeration unit; and

FIG. 6 is a schematic view of still another embodiment of a frame support for a cargo container refrigeration unit.

The detailed description explains embodiments of the invention, together with advantages and features, by way of example with reference to the drawing.

### DETAILED DESCRIPTION OF THE INVENTION

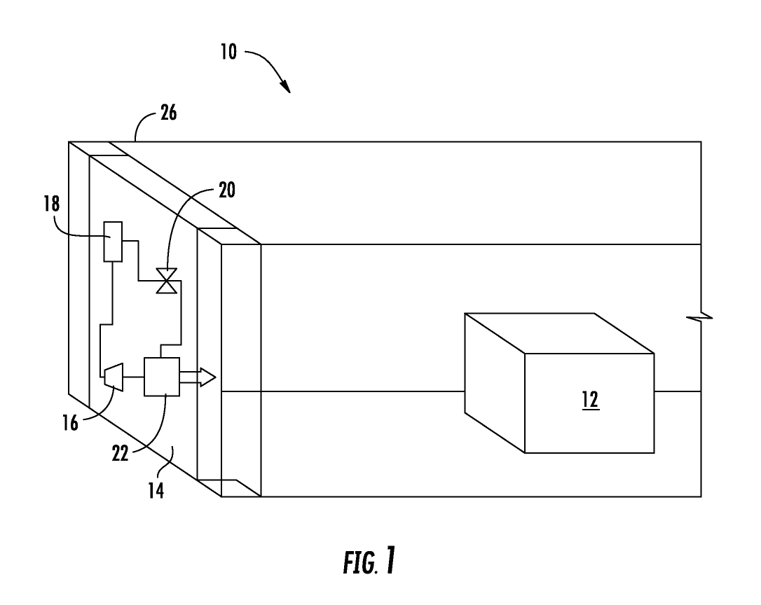

Shown in FIG. 1 is an embodiment of a refrigerated cargo container 10. The cargo container 10 is configured to maintain a cargo 12 located inside the cargo container 10 at a selected temperature through the use of a refrigeration unit 14 located at the container 10. The cargo container 10 is utilized to transport the cargo 12 via, for example, a truck, a train or a ship. The refrigeration unit 14 includes a compressor 16, a condenser 18, an expansion valve 20, an evaporator 22 and an evaporator fan (not shown) located at, for example, a first end 26 of the container 10.

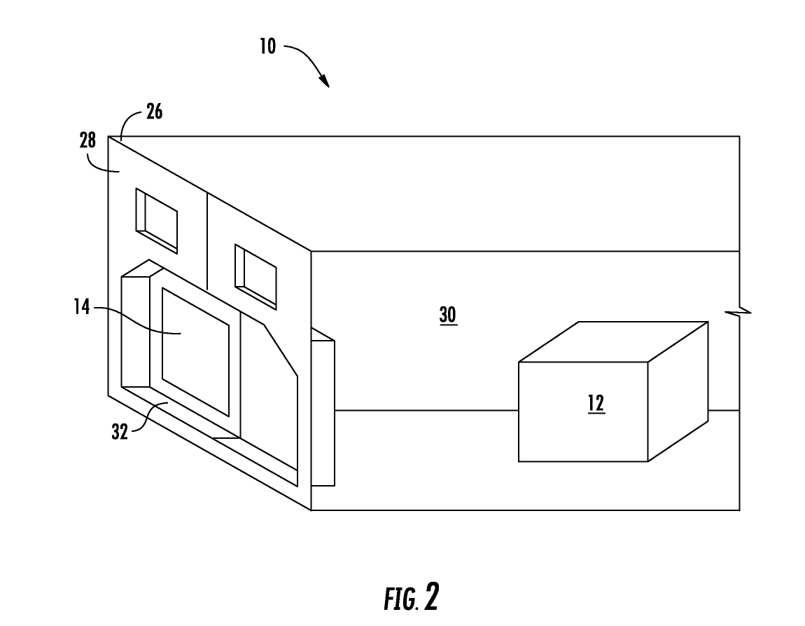

Referring to FIG. 2, the first end 26 comprises a frame 28. The frame 28 separates a cargo portion 30 of the container 10 from the refrigeration unit 14 and insulates the cargo portion 30. In some embodiments, the components of the refrigeration unit 14, such as the compressor 16, condenser 18, expansion valve 20, evaporator 22 and evaporator fan 24, as well as any connecting tubing or piping and any additional components (not shown) are located at and secured to the frame 28. In some embodiments, the frame 28 includes a recessed pocket 32 in which some components of the refrigeration unit 14 is located and secured. The frame 28 is configured to support the refrigeration unit 14 and to carry substantial loads of the container 10 such as racking and end loads.

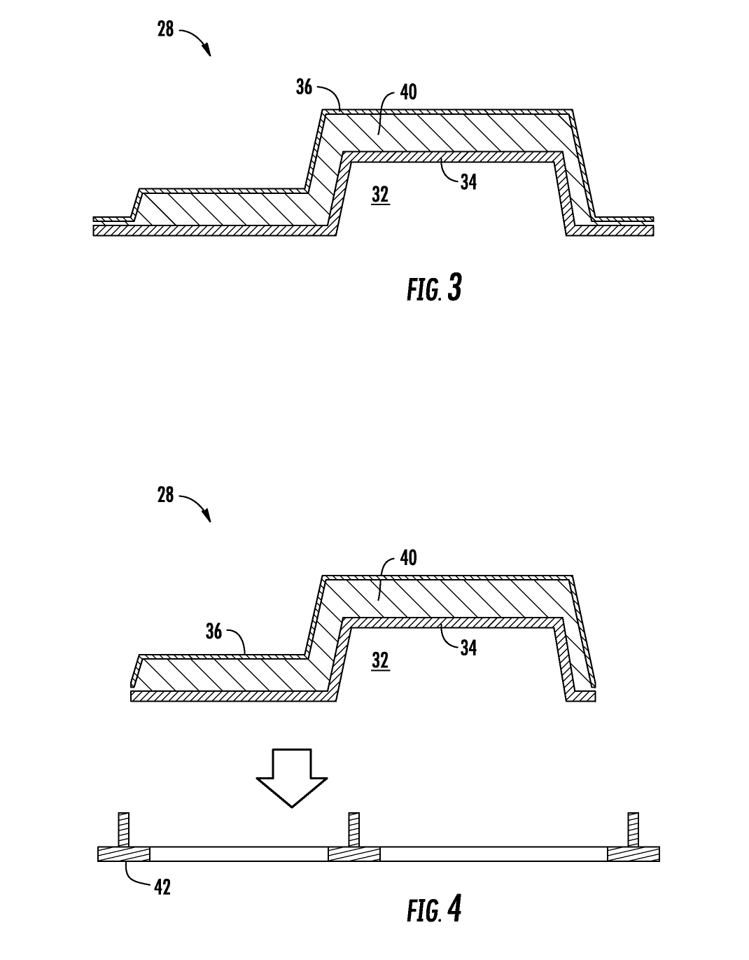

Referring to FIG. 3, the frame 28 is a molded composite structure including outer skin 34 and inner skin 36 formed from, for example, fiber reinforced polymer matrix composite (FRPMC) material. A layer of insulation 40, such as a foam insulation, is disposed between the outer skin 34 and inner skin 36. In some embodiments, the insulation 40 is pre-manufactured and formed to a selected shape and integrated into the frame 28 structure by a composite manufacturing process such as vacuum infusion (VI), resin transfer molding (RTM), lite resin transfer molding (LRTM), or the like. As such, the outer skin 34, inner skin 36 and insulation are co-cured. Alternatively, the outer skin 34 and the inner skin 36 are pre-manufactured with sheet molding compound (SMC) and compression molding and assembled. The insulation 40 is then installed by, for example, injection of the insulation 40 as a foam.

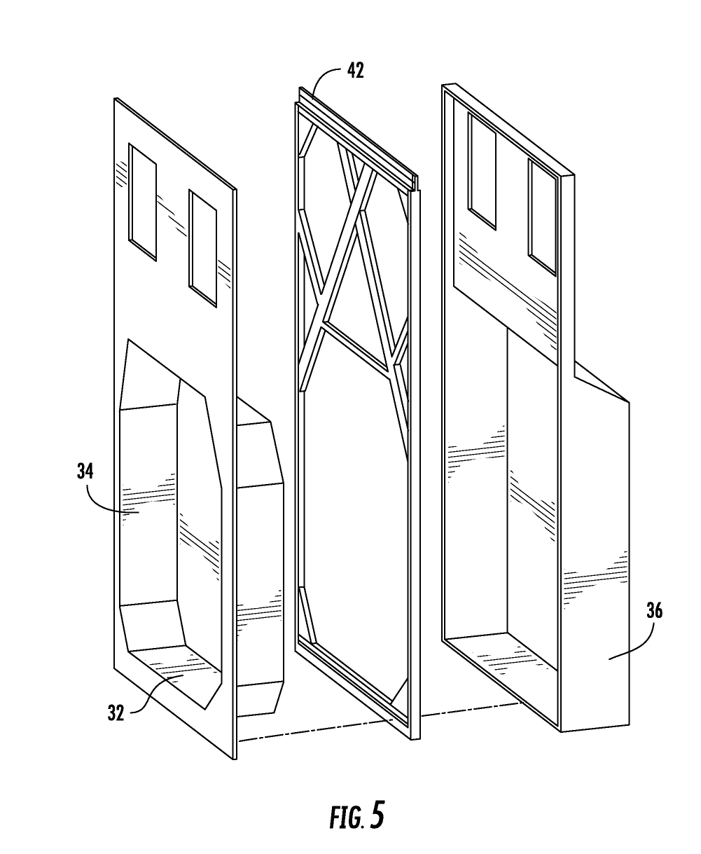

Referring now to FIG. 4, the frame 28 may include a stiffener 42 formed from a metal, such as aluminum or an alloy thereof to provide additional stiffness to the frame 28 structure if necessary or desired, especially in areas such as a perimeter of the frame 28. To incorporate the stiffener 42 into the frame 28 structure, the stiffener 42 may be bonded into the frame 28 in a composite frame cure cycle. Alternatively, the stiffener 42 may be assembled to the completed outer skin 34, inner skin 36 and insulation structure 40, either by bonding with adhesives and/or with mechanical fasteners such as bolts (not shown).

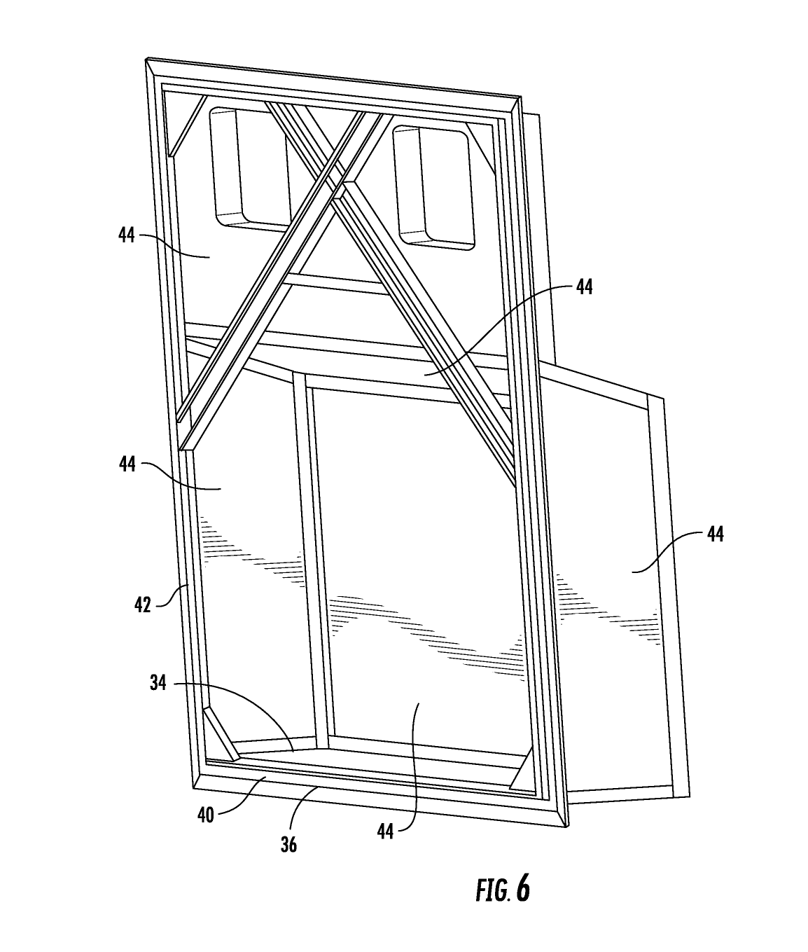

Referring to the embodiment shown in FIG. 5, the stiffener 42 is located in the frame 28 between the inner skin 36 and the outer skin 34. The stiffener 42, inner skin 36 and outer skin 34 are secured by, for example, bonding. Foam insulation 40 is then injected between the layers of the frame 28.

In another embodiment, shown in FIG. 6, the stiffener 42 is formed by stamping, welding or other suitable means, then pre-formed frame panels 44 are secured to the stiffener 42. The frame panels 44, as in other embodiments, include an outer skin 34 and inner skin 36, with a layer of insulation 40 between the outer skin 34 and the inner skin 36.

The composite frame 28 structure secures the components of the refrigeration system 14, while also carrying loads and providing insulation of the cargo portion 30 of the container 10, while reducing weight and being less susceptible to corrosion.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A refrigerated cargo container comprising:
a cargo container; and
a refrigeration unit including a support frame formed from at least one layer of composite material and at least one layer of insulative foam material, the support frame supportive of one or more components of the refrigeration unit and insulative of a cargo portion of the cargo container.

2. The refrigerated cargo container of claim 1, wherein the support frame includes two layers of composite material with the at least one layer of insulative foam material disposed therebetween.

3. The refrigerated cargo container of claim 1, the support frame further comprising a metal stiffener member.

4. The refrigerated cargo container of claim 3, wherein the stiffener member is formed from an aluminum material.

5. The refrigerated cargo container of claim 1, wherein the at least one layer of composite material is a fiber reinforced polymer matrix composite material.

6. The refrigerated cargo container of claim 1, wherein the support frame is formed by one of vacuum infusion, resin transfer molding or lite resin transfer molding.

7. The refrigerated cargo container unit of claim 1, wherein the layer of composite material is formed via compression molding using sheet molding compound.

8. The refrigerated cargo container of claim 1, wherein the support frame is disposed at a first end of the refrigerated cargo container.

9. The refrigerated container of claim 1, wherein the support frame includes at least one recessed pocket.

10. The refrigerated cargo container of claim 8, wherein the one or more components of the refrigeration unit are disposed at the at least one recessed pocket.

11. A support frame for a refrigeration unit of a refrigerated cargo container comprising:
one or more layers of composite material; and
at least one layer of thermally insulative material secured thereto, the support frame supportive of one or more components of the refrigeration unit and thermally insulative of a cargo portion of the cargo container.

12. The support frame of claim 11, wherein the support frame includes two layers of composite material with the at least one layer of insulative foam material disposed therebetween.

13. The support frame of claim 11, wherein the support frame is formed by one of vacuum infusion, resin transfer molding or lite resin transfer molding.

14. The support frame of claim 11, further comprising a metal stiffener member.

15. The support frame of claim 14, wherein the stiffener member is formed from an aluminum material.

16. The support frame of claim 11, wherein the at least one layer of composite material is a fiber reinforced polymer matrix composite material.

17. The support frame of claim 11, wherein the layer of composite material is formed via compression molding using sheet molding compound.

18. The support frame of claim 11, wherein the support frame includes at least one recessed pocket.

19. The support frame of claim 18, wherein the at least one recessed pocket is receptive of one or more components of the refrigeration unit.
